(19) United States
(12) Patent Application Publication
(10) Pub. No.: US 2018/0292927 A1
(43) Pub. Date: Oct. 11, 2018

(54) TOUCH ELECTRODE ARRAY AND TOUCH DISPLAY APPARATUS

(71) Applicant: Au Optronics Corporation, Hsinchu (TW)

(72) Inventors: Yu-Chin Chu, Keelung City (TW); Sheng-Wen Cheng, Hsinchu City (TW)

(73) Assignee: Au Optronics Corporation, Hsinchu (TW)

(21) Appl. No.: 15/641,227

(22) Filed: Jul. 4, 2017

(30) Foreign Application Priority Data
Apr. 10, 2017 (TW) 106111838

(51) Int. Cl. G06F 3/041

(52) U.S. Cl. CPC G06F 3/041; G06F 2203/04111

(57) ABSTRACT

A touch electrode array disposed on a substrate and including at least one first sensing electrode and at least one protective electrode is provided. The first sensing electrode is formed by a network structure. The network structure includes a solid portion and at least one opening portion defined by the solid portion. The at least one protective electrode overlaps with the at least one opening potion in one direction. Moreover, a touch display apparatus including the touch electrode array is also provided.

### CROSS-REFERENCE TO RELATED APPLICATION

This application claims the priority benefit of Taiwan application serial no. 106111838, filed on Apr. 10, 2017. The entirety of the above-mentioned patent application is hereby incorporated by reference herein and made a part of this specification.

### BACKGROUND OF THE INVENTION

### Field of the Invention

The invention relates to an electrode array and a display apparatus including the electrode array, and particularly relates to a touch electrode array and a touch display apparatus.

### Description of Related Art

In recent years, touch panel has become one of popular electronic apparatuses in daily life. The electronic apparatus generally includes a plurality of signal lines for transmitting signals. However, these signal lines may become discharge paths of electrostatic discharge (ESD). Particularly, the finer the signal line is, the easier it is damaged by a large current produced in ESD, which causes damage of the signal line. Taking the touch panel as an example, the region most likely damaged by the ESD is concentrated at a bridge portion of a sensing electrode. The bridge portion damaged by the ESD may cause reduction of yield and reliability of the touch panel. Therefore, how to design a touch panel having an ESD protection function is one of the targets to be achieved by related technicians.

### SUMMARY OF THE INVENTION

The invention is directed to a touch electrode array, which is not easy to be damaged by static electricity to lose a touch function.

An embodiment of the invention provides a touch electrode array disposed on a substrate and including at least one first sensing electrode and at least one protective electrode. The first sensing electrode is formed by a network structure. The network structure includes a solid portion and at least one opening portion defined by the solid portion. The at least one protective electrode overlaps with the at least one opening potion in one direction.

An embodiment of the invention provides a touch electrode array including a plurality of first sensing series, a plurality of second sensing series and an insulation layer. The first sensing series are located on a substrate. The substrate has a middle region and an edge region substantially surrounding the middle region. Each of the first sensing series includes a plurality of first sensing electrodes and a plurality of first bridge portions, each of the first bridge portions is electrically connected between two adjacent first sensing electrodes. The second sensing series are intersected with the first sensing series at the first bridge portions. At least a part of the insulation layer is located between the first bridge portion and one corresponding second sensing series. The insulation layer includes a thick portion located in the edge region and a thin portion located in the middle region.

In an embodiment of the invention, the solid portion includes at least one trigger portion disposed corresponding to the at least one protective electrode. At least one of the at least one trigger portion and the at least one protective electrode has at least one protrusion portion.

In an embodiment of the invention, the protrusion portion includes a sharp end.

In an embodiment of the invention, the solid portion further includes a plurality of network lines interwoven into a network. The at least one trigger portion is electrically connected to at least one of the network lines, and the at least one trigger portion extends towards a direction different to a length direction of the at least one of the network lines.

In an embodiment of the invention, the at least one protrusion portion includes at least one first protrusion portion and at least one second protrusion portion. The solid portion and the at least one protective electrode respectively have the at least one first protrusion portion and the at least one second protrusion portion, an extending direction of the at least one first protrusion portion is opposite to an extending direction of the at least one second protrusion portion.

In an embodiment of the invention, the solid portion of the at least one first sensing electrode is partially overlapped with the at least one protective electrode.

In an embodiment of the invention, the at least one opening portion is, for example, a enclosed opening or an unenclosed opening.

In an embodiment of the invention, the touch electrode array further includes an insulation layer covering one of the at least one first sensing electrode and the at least one protective electrode, and the other one of the at least one first sensing electrode and the at least one protective electrode is disposed on the insulation layer.

In an embodiment of the invention, the at least one first sensing electrode is a plurality of first sensing electrodes, and the touch electrode array further includes a plurality of first bridge portions, and each of the first bridge portions is electrically connected between two adjacent first sensing electrodes. The insulation layer covers one of the first sensing electrodes and the first bridge portions, and the other one of the first sensing electrodes and the first bridge portions are disposed on the insulation, and the at least one protective electrode and the first bridge portions are constructed from a same film layer.

In an embodiment of the invention, the at least one first sensing electrode is a plurality of first sensing electrodes, and the touch electrode array further includes a plurality of first bridge portions, where each of the first bridge portions is electrically connected between two adjacent first sensing electrodes. The insulation layer covers one of the first sensing electrodes and the first bridge portions, and the other one of the first sensing electrodes and the first bridge portions are disposed on the insulation. The insulation layer includes a thick portion and a thin portion. The thick portion is overlapped with the first bridge portion, and the thin portion is disposed between the at least one first sensing electrode and the at least one protective electrode.

In an embodiment of the invention, the touch electrode array further includes a plurality of second sensing electrodes and a plurality of second bridge portions. Each of the second bridge portions is electrically connected between two adjacent sensing electrodes and intersected with one corresponding first bridge portion. The thick portion is disposed between the second bridge portion and the corresponding first bridge portion.

In an embodiment of the invention, the substrate has a middle region and an edge region substantially surrounding the middle region. The first sensing electrodes and the first bridge portions construct at least one first sensing series. A thickness of a part of the thin portion of the insulation layer located in the middle region is different to a thickness of another part of the thin portion of the insulation layer located in the edge region.

In an embodiment of the invention, the thickness of the part of the thin portion of the insulation layer located in the middle region is greater than the thickness of the other part of the thin portion of the insulation layer located in the edge region.

In an embodiment of the invention, the thickness of the part of the thin portion of the insulation layer located in the middle region is smaller than the thickness of the other part of the thin portion of the insulation layer located in the edge region.

In an embodiment of the invention, the at least one protective electrode is floating.

An embodiment of the invention provides another touch electrode array including a plurality of first sensing series, a plurality of second sensing series, at least one protective electrode and an insulation layer. Each of the first sensing series includes a plurality of first sensing electrodes and a plurality of first bridge portions, where each of the first bridge portions is electrically connected between two adjacent first sensing electrodes. The second sensing series are intersected with the first sensing series at the first bridge portions. The at least one protective electrode is disposed corresponding to the at least one first sensing electrode. The insulation layer includes a thick portion and a thin portion. The thick portion is disposed between each of the first bridge portions and one corresponding second sensing series. The thin portion is disposed between the at least one first sensing electrode and the at least one protective electrode.

In another embodiment of the invention, the touch electrode layer is disposed on a substrate, a distance between an upper surface of each of the first bridge portions and a lower surface of one corresponding second sensing series in a direction perpendicular to the substrate is D, and a distance between an upper surface of the at least one protective electrode and a plane where the at least one first sensing electrode is located in the direction perpendicular to the substrate is D′, where D>D′.

In another embodiment of the invention, the touch electrode array is disposed on a substrate. The substrate has a middle region and an edge region substantially surrounding the middle region. The first sensing series and the second sensing series are disposed in the middle region and the edge region, and a thickness of a part of the thin portion of the insulation layer located in the middle region is different to a thickness of another part of the thin portion of the insulation layer located in the edge region.

The invention provides a touch display apparatus including a display panel and a touch electrode array. The touch electrode array is disposed on the display panel.

According to the above description, the touch electrode array of the invention includes the first sensing electrodes formed by a network structure and the protective electrodes. The protective electrodes are overlapped with the opening portions of the first sensing electrodes. By configuring the protective electrodes, a chance of ESD occurred on the bridge portion is decreased, so as to improve the yield and reliability of the touch electrode array.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a touch electrode array according to an embodiment of the invention.

FIG. 2 is an enlarged view of a region R of the touch electrode array of FIG. 1.

FIG. 3 is a cross-sectional view of the touch electrode array of FIG. 2 viewing along a section line I-I′.

FIG. 4 is a cross-sectional view of the touch electrode array of FIG. 1 at a middle region and an edge region.

FIG. 5 is an enlarged view of a touch electrode array according to another embodiment of the invention.

FIG. 6 is a cross-sectional view of the touch electrode array of FIG. 5 viewing along a section line I-I′.

FIG. 7 is a schematic diagram of a touch display apparatus according to an embodiment of the invention.

### DESCRIPTION OF EMBODIMENTS

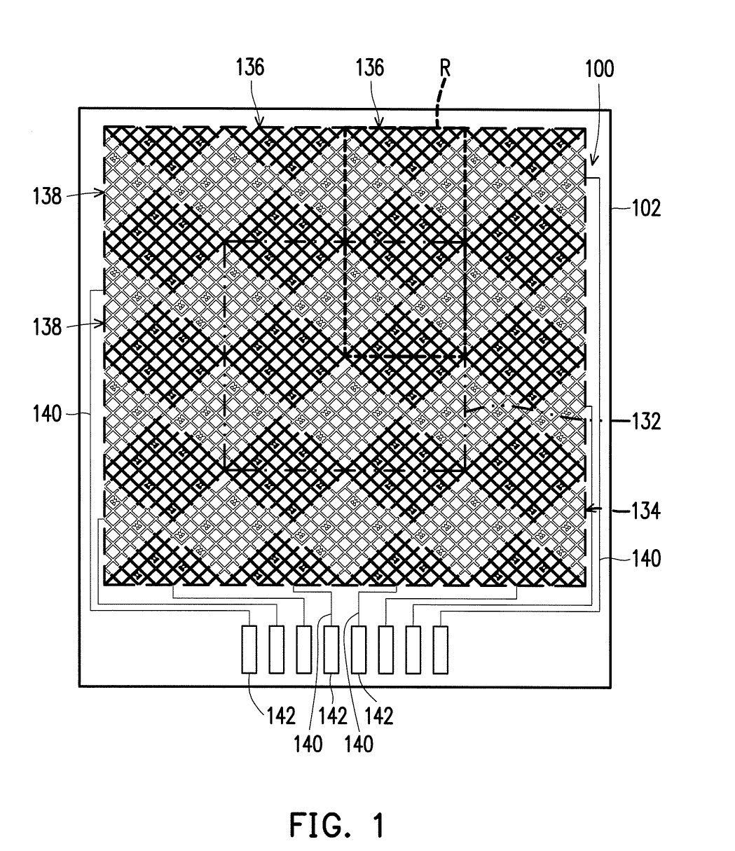

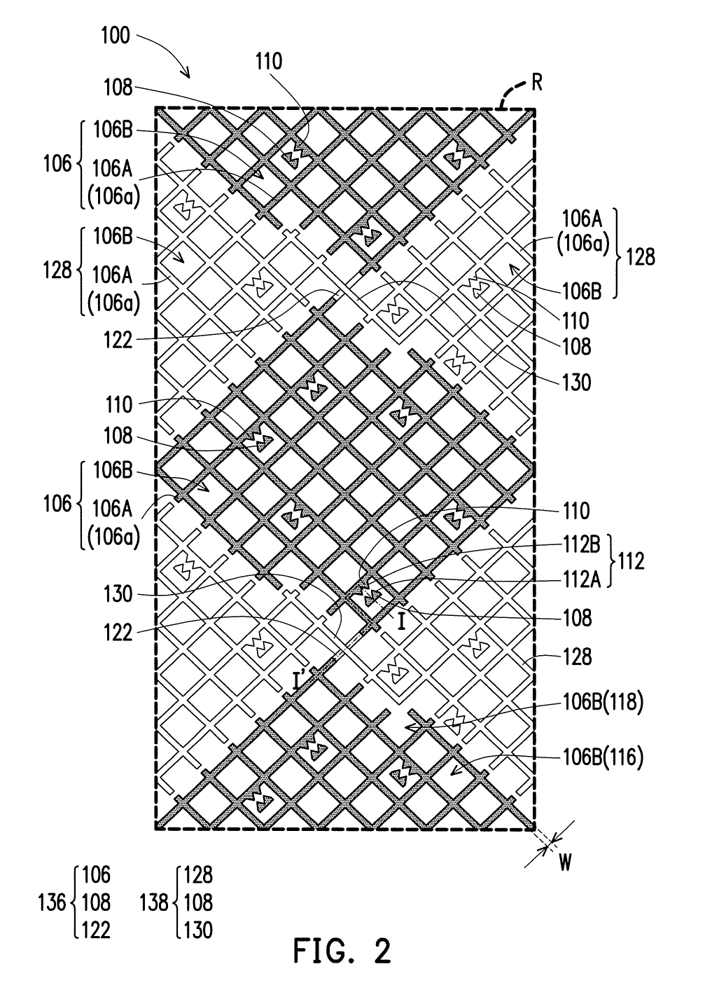

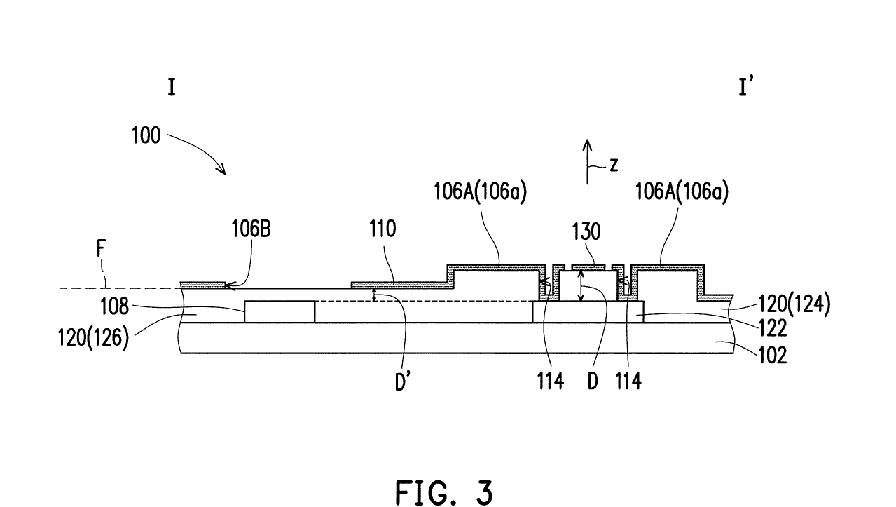

FIG. 1 is a top view of a touch electrode array according to an embodiment of the invention. FIG. 2 is an enlarged view of a region R of the touch electrode array of FIG. 1. FIG. 3 is a cross-sectional view of the touch electrode array of FIG. 2 viewing along a section line I-I′.

Referring to FIG. 1, the touch electrode array 100 is disposed on a substrate 102. The substrate 102 has a middle region 132 and an edge region 134. The edge region 134 substantially surrounds the middle region 132, though the invention is not limited thereto, and ranges of the middle region 132 and the edge region 134 can be varied according to a design need. In the present embodiment, materials of the substrate 102 can be glass, quartz, organic polymer, an opaque/reflective material (for example, wafers, ceramics or other suitable materials) or other suitable materials.

Referring to FIG. 1 and FIG. 2, the touch electrode array 100 includes first sensing series 136. Each of the first sensing series 136 includes first sensing electrode 106 and protective electrode 108 corresponding to the first sensing electrode 106. In the present embodiment, the touch electrode array 100 further includes second sensing series 138 intersected with the first sensing series 136. The first sensing series 136 and the second sensing series 138 can be respectively connected to pads 142 through transmission lines 140, and electrically connected to other device (for example, a driving chip) through the pads 142.

In the present embodiment, each of the first sensing series 136 may include first sensing electrodes 106 and first bridge portions 122. Each of the first bridge portions 122 is electrically connected between two adjacent first sensing electrodes 106. Each of the second sensing series 138 includes second sensing electrodes 128 and second bridge portions 130. Each of the second bridge portions 130 is electrically connected between two adjacent second sensing electrodes 128. The second sensing series 138 are intersected with the first sensing series 136 at the first bridge portions 122. Referring to FIG. 2 and FIG. 3, in detail, the first bridge portions 122 of the first sensing series 136 are intersected with the second bridge portions 130 of the second sensing series 138, and an insulation layer 120 is disposed between the corresponding first bridge portions 122 and the second bridge portions 130.

Referring to FIG. 2, the first sensing electrode 106 (and/or the second sensing electrode 128) is formed by a network structure. The network structure includes a solid portion 106A and at least one opening portion 106B defined by the solid portion 106A. The opening portion 106B can be enclosed opening 116 or unenclosed opening 118. For example, in the present embodiment, the opening portion 106B can be selectively the enclosed opening 116 or the unenclosed opening 118, where the enclosed opening 116 can be located in internal of the first sensing electrode 106 (and/or the second sensing electrode 128), and the unenclosed opening 118 can be located at an edge of the first sensing electrode 106 (and/or the second sensing electrode 128), though the invention is not limited thereto. Moreover, in the present embodiment, the solid portion 106A may selectively include trigger portion 110 disposed corresponding to the protective electrode 108. In detail, in the present embodiment, the solid portion 106A includes network lines 106a. The network lines 106a are interwoven into a network. The trigger portions 110 are electrically connected to the network lines 106a, and the trigger portion 110 extends toward a direction different to a length extending direction of the network line 106a connected thereto. In the present embodiment, a width W of the network line 106a is, for example, 4 μm-7 μm, though the invention is not limited thereto.

Referring to FIG. 2 and FIG. 3, the protective electrode 108 is disposed corresponding to the first sensing electrode 106 (and/or the second sensing electrode 128). In the present embodiment, the protective electrode 108 can be completely overlapped with the opening portion 106B in direction z, and the protective electrode 108 is not overlapped with the solid portion 106A in the direction z, where the direction z is a normal direction of the substrate 102. In other variations, the protective electrode 108 is not located between any two adjacent first sensing electrodes 106 and the protective electrode 108 is not located between any two adjacent second sensing electrodes 128. Moreover, in the present embodiment, the protective electrode 108 may be floating.

Referring to FIG. 2, in the present embodiment, both of the trigger portion 110 of the solid portion 106A and the corresponding protective electrode 108 have protrusion portion 112, though the invention is not limited thereto. In other variations, only one of the trigger portion 110 and the corresponding protective electrode 108 has protrusion portion 112. In FIG. 2, in the present embodiment, the protective electrode 108 has first protrusion portion 112A, the trigger portion 110 has a second protrusion portion 112B, and an extending direction of the second protrusion portion 112B of the trigger portion 110 is opposite to an extending direction of the first protrusion portion 112A of the protective electrode 108, though the invention is not limited thereto. In the present embodiment, the protrusion portion 112 includes sharp end. To be specific, the protrusion portion 112 can be triangular conductive patterns connected to each other. However, the invention is not limited thereto, and the shape of the protrusion portion 112 can be varied along with an actual design requirement and/or a process condition. For example, the sharp end of the triangular conductive pattern has an arc shape.

Referring to FIG. 2 and FIG. 3, the touch electrode array 100 further includes an insulation layer 120 (shown in FIG. 3). The insulation layer 120 covers one of the first sensing electrode 106 and the protective electrode 108, and the other one of the first sensing electrode 106 and the protective electrode 108 is disposed on the insulation layer 120. For example, the insulation layer 120 covers the protective electrode 108, and the first sensing electrode 106 is disposed on the insulation layer 120. In other words, the insulation layer 120 is located between the first sensing electrode 106 and the protective electrode 108. Further, in the present embodiment, the insulation layer 120 covers one of the first sensing electrode 106 and the first bridge portion 122, and the other one of the first sensing electrode 106 and the first bridge portion 122 is disposed on the insulation layer 120. For example, the insulation layer 120 covers the first bridge portion 122, and the first sensing electrode 106 is disposed on the insulation layer 120.

Referring to FIG. 1, FIG. 2 and FIG. 3, in the present embodiment, the protective electrodes 108 and the first bridge portions 122 may be patterned by same layer. The insulation layer 120 is formed to cover the protective electrodes 108 and the first bridge portions 122. The first sensing electrodes 106 and the second sensing series 138 may be patterned by same layer. The first sensing electrodes 106 and the second sensing series 138 are disposed on the insulation layer 120. The insulation layer 120 has contact windows 114 exposing each of the first bridge portions 122, and two adjacent first sensing electrodes 106 can be electrically connected to a same first bridge portion 120 through two corresponding contact windows 114. It should be noted that a manufacturing process of the first sensing series 136, the second sensing series 138 and the insulation layer 120 and film layer relationships of the components thereof are only an example and are not used for limiting the invention, and the manufacturing process of the first sensing series 136, the second sensing series 138 and the insulation layer 120 and the film layer relationships of the components thereof can be suitably modified according to an actual requirement, which is not limited by the invention.

Referring to FIG. 2 and FIG. 3, it should be noted that in the present embodiment, the insulation layer 120 may selectively include a thick portion 124 and a thin portion 126. The thick portion 124 is disposed between the first bridge portion 122 and one corresponding second sensing series 138 and is overlapped with the first bridge portion 122. A part of the thick portion 124 can be disposed between the second bridge portion 130 and the corresponding first bridge portion 122. The thin portion 126 can be disposed between the first sensing electrode 106 and the protective electrode 108. According to another aspect, a distance between an upper surface of the first bridge portion 122 and a lower surface of the corresponding second sensing series 138 in a direction z is D, and a distance between an upper surface of the protective electrode 108 and a virtual plane F where the first sensing electrode 106 is located in the direction z is D′, where D>D′. In this way, electrostatic discharge (ESD) is liable to be produced on the protective electrode 108, and is not liable to be produced on the first bridge portion 122 and/or the second bridge portion 130, so as to further decrease a chance that the touch electrode array 100 is damaged by ESD. In the present embodiment, D is about 2000 Å-8000 Å, though the invention is not limited thereto.

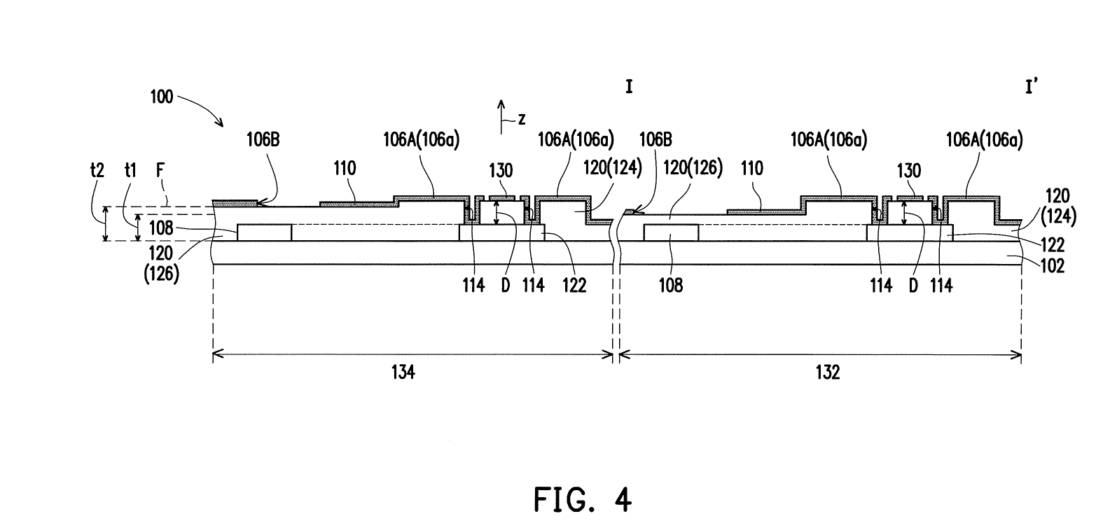

FIG. 4 is a cross-sectional view of the touch electrode array 100 of FIG. 1 at the middle region 132 and the edge region 134. Referring to FIG. 1 and FIG. 4, liability of ESD of each region of the substrate 102 is probably different. In the present embodiment, whether the insulation layer 120 of each region includes the thin portion 126 can be determined by liability of ESD of each region, or even the thickness of the thin portion 126 of each region is designed to be the same or different. For example, in the present embodiment, the thickness of a part of the thin portion 126 located in the middle region 132 can be different to the thickness of the other part of the thin portion 126 located in the edge region 134. If the ESD is liable to be occurred in the middle region 132, the thickness t1 of a part of the thin portion 126 located in the middle region 132 can be smaller than the thickness t2 of the other part of the thin portion 126 located in the edge region 134. Therefore, a capacitance formed between the protective electrode 109 and the first sensing electrode 106 set in an ESD liable region is greater than a capacitance formed between the protective electrode 109 and the first sensing electrode 106 set in a ESD non-liable region, such that an ESD protection effect of the ESD liable region is superior to an ESD protection effect of the ESD non-liable region. In this way, the chance that the touch electrode array 100 is damaged by ESD is further decreased. It should be noted that it is not limited to set the thin portion 126 of the insulation layer 120 in both of the ESD liable region (for example, the middle region 132) and the ESD non-liable region (for example, the edge region 134), and in other embodiment, the thin portion 126 can be set in the ESD liable region, and the thin portion 126 is not set in the ESD non-liable region.

In the present embodiment, a tri-tone mask patterned insulation material layer (not shown) can be used to form the insulation layer 120 having the thick portion 124 and the thin portion 126 with different thicknesses, though the invention is not limited thereto, and any method suitable for adjusting a film thickness of each region of the insulation material layer (not shown) can be used for forming the insulation layer 120 of the invention.

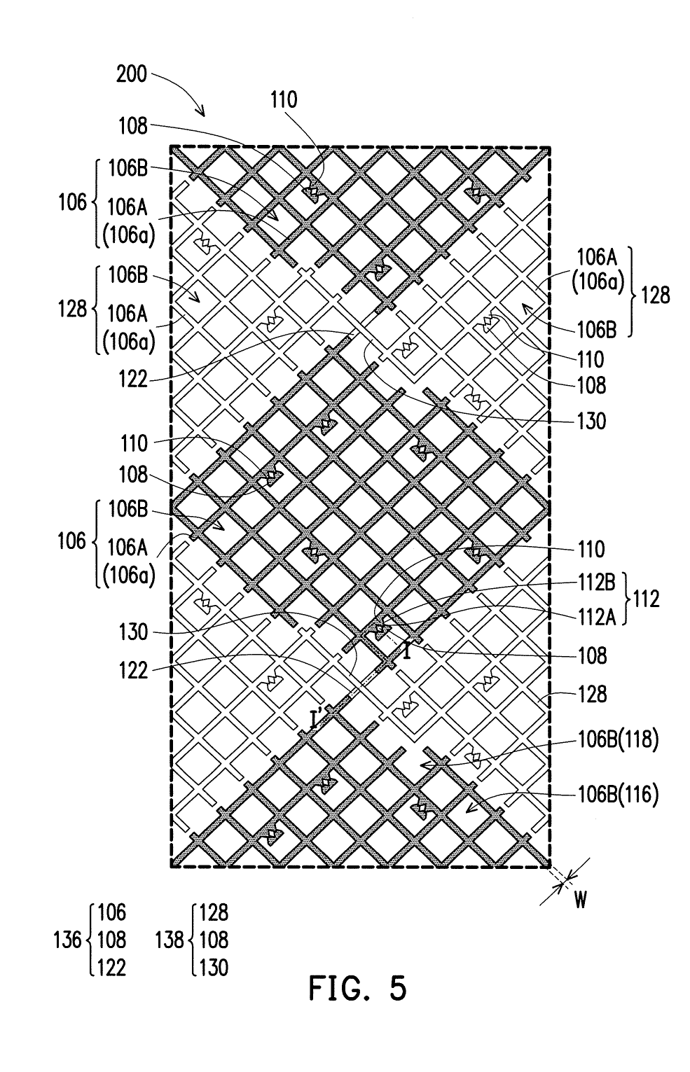

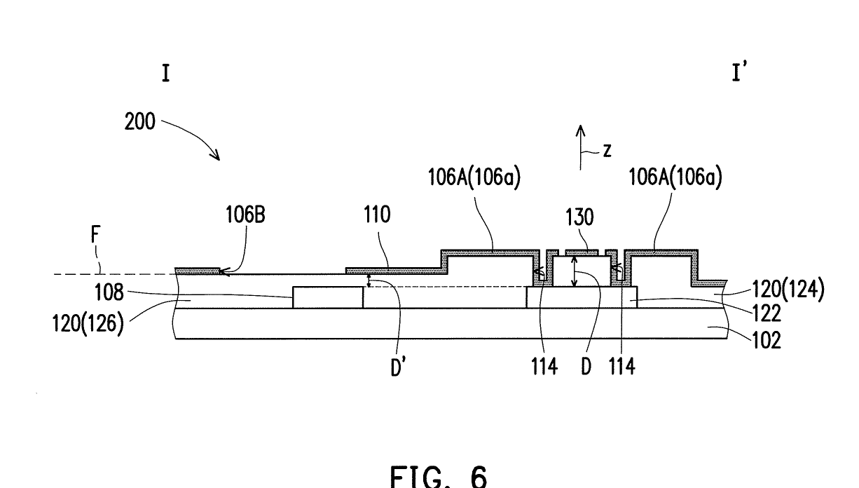

FIG. 5 is an enlarged view of a touch electrode array according to another embodiment of the invention. FIG. 6 is a cross-sectional view of the touch electrode array viewing along a section line I-I′ of FIG. 5. A basic structure of the touch electrode array 200 is similar to the base structure of the touch electrode array 100, so that the same or corresponding components are denoted by the same or corresponding referential numbers. Unless otherwise specified, detailed descriptions of various components of the touch electrode array 200 may refer to the aforementioned description. Referring to FIG. 5 and FIG. 6, a main difference between the touch electrode array 200 and the touch electrode array 100 is that the solid portion 106A of the first sensing electrode 106 (and/or the second sensing electrode 128) can be partially overlapped with the at least one protective electrode 108 in the direction z. In the present embodiment, the second protrusion portion 112B of the trigger portion 110 can be overlapped with the first protrusion portion 112A of the protective electrode 108. Therefore, the distance between the solid portion 106A and the protective electrode 108 can be further decreased to increase a capacitance between the solid portion 106A and the protective electrode 108. In this way, the ESD is more liable to be occurred on the protective electrode 108, and the protection effect of the protective electrode 108 is further improved.

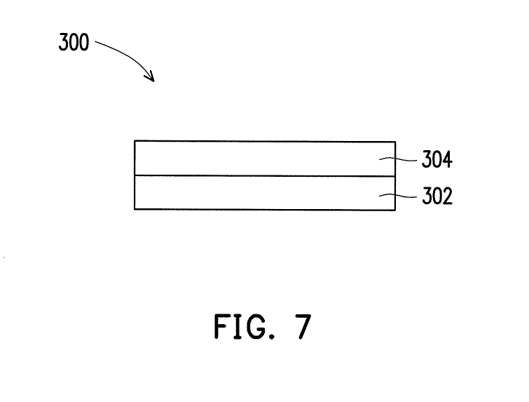

FIG. 7 is a schematic diagram of a touch display apparatus according to an embodiment of the invention. Referring to FIG. 7, the touch display apparatus 300 includes a display panel 302 and a touch electrode array 304 disposed on the display panel 302. The touch electrode array 304 can be the aforementioned touch electrode array 100 or the touch electrode array 200. In the present embodiment, the touch electrode array 304 can be formed on another substrate outside the display panel 302, and the touch electrode array 304 and the other substrate form a touch panel, and the touch panel can be attached to an outer surface of the display panel 302. Namely, in the present embodiment, the touch display apparatus 300 can be an out-cell touch display apparatus 300. However, the invention is not limited thereto, and in other embodiment, the touch electrode array 304 can be directly formed on the outer surface of the display panel 302 to form an on-cell touch display apparatus with the display panel 302, or the touch electrode array can be formed within the display panel to form an in-cell touch display apparatus.

In summary, the touch electrode array includes the first sensing electrodes formed by a network structure and the protective electrodes. The protective electrodes are overlapped with the opening portions of the first sensing electrodes. By configuring the protective electrodes, a chance of ESD occurred on the bridge portion is decreased, so as to improve the yield and reliability of the touch electrode array.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch electrode array, disposed on a substrate, and comprising:
at least one first sensing electrode, formed by a network structure, wherein the network structure comprises a solid portion and at least one opening portion defined by the solid portion; and
at least one protective electrode, wherein the at least one protective electrode overlaps with the at least one opening potion.

2. The touch electrode array as claimed in claim 1, wherein the solid portion comprises at least one trigger portion disposed corresponding to the at least one protective electrode, and the at least one trigger portion and/or the at least one protective electrode has at least one protrusion portion.

3. The touch electrode array as claimed in claim 2, wherein the protrusion portion comprises a sharp end.

4. The touch electrode array as claimed in claim 2, wherein the solid portion further comprises:
a plurality of network lines, interwoven into a network, wherein the at least one trigger portion is electrically connected to at least one of the network lines, and the at least one trigger portion extends towards a direction different to a length direction of the at least one of the network lines.

5. The touch electrode array as claimed in claim 1, wherein the solid portion has a plurality of first protrusion portions, the at least one protective electrode respectively has a plurality of second protrusion portions, and an extending direction of one of the first protrusion portions is opposite to an extending direction of one of the second protrusion portions corresponding to the one of the first protrusion portions.

6. The touch electrode array as claimed in claim 1, wherein a normal projection of the at least one protective electrode on the substrate is completely located within the at least one opening portion.

7. The touch electrode array as claimed in claim 1, wherein the solid portion of the at least one first sensing electrode is partially overlapped with the at least one protective electrode.

8. The touch electrode array as claimed in claim 1, wherein the at least one opening portion is a enclosed opening.

9. The touch electrode array as claimed in claim 1, wherein the at least one opening portion is an unenclosed opening.

10. The touch electrode array as claimed in claim 1, further comprising:
an insulation layer, covering one of the at least one first sensing electrode and the at least one protective electrode, wherein the other one of the at least one first sensing electrode and the at least one protective electrode is disposed on the insulation layer.

11. The touch electrode array as claimed in claim 10, wherein the at least one first sensing electrode comprises a plurality of first sensing electrodes, and the touch electrode array further comprises:
a plurality of first bridge portions, and each of the first bridge portions is electrically connected between two adjacent first sensing electrodes, the insulation layer covers one of the first sensing electrodes and the first bridge portions, and the other one of the first sensing electrodes and the first bridge portions are disposed on the insulation, and the at least one protective electrode and the first bridge portions are patterned by a same layer.

12. The touch electrode array as claimed in claim 10, wherein the at least one first sensing electrode comprises a plurality of first sensing electrodes, and the touch electrode array further comprises:
a plurality of first bridge portions, wherein each of the first bridge portions is electrically connected between two adjacent first sensing electrodes, the insulation layer covers one of the first sensing electrodes and the first bridge portions, and the other one of the first sensing electrodes and the first bridge portions are disposed on the insulation, and the insulation layer comprises:
a thick portion, overlapped with the first bridge portion; and
a thin portion, disposed between the at least one first sensing electrode and the at least one protective electrode.

13. The touch electrode array as claimed in claim 12, wherein the substrate has a middle region and an edge region substantially surrounding the middle region, the first sensing electrodes and the first bridge portions are connected serially to form at least one first sensing series, and a thickness of a part of the thin portion located in the middle region is different to a thickness of another part of the thin portion located in the edge region.

14. The touch electrode array as claimed in claim 13, wherein the thickness of the part of the thin portion located in the middle region is greater than the thickness of the other part of the thin portion located in the edge region.

15. The touch electrode array as claimed in claim 13, wherein the thickness of the part of the thin portion located in the middle region is smaller than the thickness of the other part of the thin portion located in the edge region.

16. The touch electrode array as claimed in claim 1, wherein the at least one protective electrode is floating.

17. A touch electrode array, comprising:
a plurality of first sensing series, each of the first sensing series comprising:
a plurality of first sensing electrodes; and
a plurality of first bridge portions, each of the first bridge portions being electrically connected between two adjacent first sensing electrodes;
a plurality of second sensing series, electrically isolated from the first sensing series and intersected with the first sensing series at the first bridge portions;
at least one protective electrode, disposed corresponding to the at least one first sensing electrode; and
an insulation layer, comprising:
a thick portion, disposed between each of the first bridge portions and one corresponding second sensing series; and
a thin portion, disposed between the at least one first sensing electrode and the at least one protective electrode.

18. The touch electrode array as claimed in claim 17, wherein the touch electrode layer is disposed on a substrate, a distance between one of the first bridge portions and corresponding second sensing series in a direction perpendicular to the substrate is D, and a distance between the at least one protective electrode and a plane where the at least one first sensing electrode is located in the direction is D′, and D>D′.

19. The touch electrode array as claimed in claim 17, wherein the touch electrode array is disposed on a substrate, the substrate has a middle region and an edge region substantially surrounding the middle region, the first sensing series and the second sensing series are disposed in the middle region and the edge region, and a thickness of a part of the thin portion located in the middle region is different to a thickness of another part of the thin portion located in the edge region.

20. A touch electrode array, comprising:
a plurality of first sensing series, located on a substrate, wherein the substrate has a middle region and an edge region substantially surrounding the middle region, and each of the first sensing series comprises:
a plurality of first sensing electrodes; and
a plurality of first bridge portions, each of the first bridge portions being electrically connected between two adjacent first sensing electrodes;
a plurality of second sensing series, electrically isolated from the first sensing series and intersected with the first sensing series at the first bridge portions; and
an insulation layer, wherein at least a part of the insulation layer is located between the first bridge portion and one corresponding second sensing series, and the insulation layer comprises:
a thick portion, located in the edge region; and
a thin portion, located in the middle region.
